(19) United States
(12) Patent Application Publication
(10) Pub. No.: US 2010/0082768 A1
(43) Pub. Date: Apr. 1, 2010

(54) PROVIDING COMPONENTS FOR MULTIMEDIA PRESENTATIONS

(76) Inventors: Phillip Dean Edwards, Austin, TX (US); Raymond A. Boyd, Amarillo, TX (US)

Correspondence Address: RAMAN N. DEWAN;JACKSON WALKER, L.L.P., 100 CONGRESS AVENUE, SUITE 1100, AUSTIN, TX, 78701, US

(21) Appl. No.: 12/563,732

(22) Filed: Sep. 21, 2009

Related U.S. Application Data
(60) Provisional application No. 61/098,585, filed on Sep. 19, 2008.

(51) Int. Cl. G06F 3/01; G06F 15/16; G06F 3/048

(52) U.S. Cl. 709/217; 715/716; 709/234; 715/810

(57) ABSTRACT

Audio stems and video segments are downloaded and selectively included (e.g., through software) in a multimedia presentation. In some embodiments, a user may select lyric tracks for download and inclusion with the multimedia presentation. The video segments and lyrics tracks are synchronized with the audio stems within the multimedia presentation. Embodied services may include selectable and downloadable click tracks that having timing data that corresponds to other downloaded components. In some embodiments, audio stems are selectable according to a musical key.

This application claims priority from provisional application 61/098,585 filed Sep. 19, 2008, which is incorporated herein by this reference as if set forth in its entirety.

### BACKGROUND

1. Field of the Disclosure

The present disclosure relates to multimedia services, and more particularly, to managing the selection and delivery of components for multimedia presentations.

2. Description of the Related Art

Music directors that conduct live musical performances may enhance the performances with pre-recorded backing tracks and video.

### BRIEF DESCRIPTION OF THE DRAWINGS

FIG. 1 depicts an exemplary environment for implementing embodied methods for processing components used for multimedia presentations;

FIG. 2 depicts a graphical user interface presented by a display of an embodied digital audio workstation (DAW);

FIG. 3 depicts speakers and a display with an exemplary screen shot of a multimedia presentation;

FIG. 4 illustrates, in block diagram form, a data processing system within which a set of instructions may operate to perform one or more of the methodologies discussed herein;

FIG. 5 depicts selected elements of a disclosed method for processing components for a multimedia presentation; and

FIG. 6 depicts selected elements of a disclosed service for providing multimedia components for a multimedia presentation.

### DESCRIPTION OF THE EMBODIMENT(S)

In one aspect, a disclosed service provides multimedia components for inclusion with a multimedia presentation. The service includes providing a plurality of audio stems and video segments for download and inclusion in the multimedia presentation. A user is enabled to select and download a portion of the audio stems and video segments. In some embodiments, a user is also enabled to select lyric data for download and inclusion with the multimedia presentation. The video segments and lyrics data can be synchronized with the audio stems within the multimedia presentation.

In some embodiments of the service, the downloaded video segments include lyrics and separate lyric data is unnecessary. Further, the portion of the audio stems that are selectable and downloadable may include digital rights management (DRM) data. The service may include buffering the selected portion of audio stems and the selected portion of video segments for inclusion in the multimedia presentation substantially in real time. The service may also include selectable and downloadable click tracks that have timing data corresponding to the downloaded audio stems. Individual frames of the downloaded video segments may include a plurality of frames that include time codes (e.g., Society of Motion Picture and Television Engineers codes). The audio stems may be arranged according to genre and may be pre-recorded. In some embodiments of the service, the audio stems are selectable according to a musical key.

In another aspect, a disclosed computer program product includes instructions for downloading one or more audio stems, downloading one or more video segments, synchronizing the downloaded video segments and the downloaded audio stems, receiving lyrics data, and synchronizing the lyrics data with the audio stems. Downloading the audio stems, video segments, and lyrics data may each include receiving associated timing data. The audio stems may be encoded for distribution to a sound mixer. In some embodiments, the lyrics data is embedded within the downloaded video. In other embodiments, the lyrics data can be entered (e.g., provided by a user with a keyboard or voice recognition system) locally by a user. A visual indicator of lyrics timing data may be included with the multimedia presentation. Further instructions provide for looping, as instructed by the user, a portion of the audio stems and/or video segments during the performance in real-time. Further instructions may validate digital rights management data prior to inclusion of lyrics data, video segments, and/or audio stems within the multimedia presentation. Further instructions enable transport controls that may include one or more of pausing, rewinding, playing, and stopping the multimedia presentation.

In still another aspect, a disclosed method for processing portions of a multimedia presentation includes downloading one or more audio stems from a service provider, downloading one or more video segments from the service provider, and selecting a portion of the downloaded audio stem(s) and video segment(s) for incorporation into the multimedia presentation. Portions of the audio stem(s) and video segment(s) may be user selected for looping within the multimedia presentation. Incorporation of the video segment(s) and audio stem(s) into the multimedia presentation may occur substantially in real time with the downloading. In some embodiments, the method includes receiving riff data and incorporating (e.g., looping) the riff data into the multimedia presentation. The method may include receiving lyrics information and encoding a video signal that includes the lyrics information and the downloaded video segment(s). In some embodiments, the lyrics information, the downloaded audio stem(s), and the downloaded video segment(s) each include timing information for synchronization. The timing information may include Society of Motion Picture and Television Engineers (SMPTE) time codes.

Accordingly, disclosed embodiments relate to providing individualized audio stems and video segments for remote user access and inclusion in one or more multimedia presentations. For example, a music director may access the individualized audio stems and video segments and turn them ON an OFF as needed, loop them as needed, and otherwise arrange them as needed for the desired multimedia presentation effects. Therefore, a user (e.g., music director) may manage a multimedia presentation that includes the performance of audible portions of a song that includes: (1) audible output derived from live musicians; and (2) audible output derived from downloaded backing tracks. The multimedia presentation may also include an associated video that is synchronized to the song. The multimedia presentation may also include song lyrics that are synchronized to the associated video and audible portions of the multimedia presentation.

As disclosed herein, the term “song” may refer to a musical composition that is comprised of one or more audio stems and one or more vocal tracks. Vocal tracks typically are derived from or simulate human voices. Stems are individual audio components that, in accordance with disclosed embodiments, may be processed for downloading and inclusion in a multimedia presentation. The term “music track” as used herein may be interchangeable with “audio stem” or “stem.”

Audio stems typically are derived from or simulate musical instruments. Some audio stems are created using synthesizers or other electronic equipment. Video segments typically include a series of images that may be displayed during the presentation of a song, and the song and video segments together make up a multimedia presentation. Song lyrics may be presented as an overlay to the video segment. In some embodiments, song lyrics are included within a downloaded video segment. Song lyrics may be inseparably imbedded in the video segment or may be electronically manipulated for inclusion with the video segment at the option of a user (e.g., music director). Disclosed embodiments may process vocal tracks, audio stems, lyric tracks, and video segments for inclusion in a multimedia presentation. For example, disclosed embodiments provide a plurality of selectable audio stems, video segments, lyric tracks, and in some embodiments, vocal tracks for selection by a musical producer during a real-time presentation of multimedia content. The producer may incorporate one or more individual tracks along with live performances of musicians that are local to the multimedia presentation. In some embodiments, multiple vocal parts may be included as part of a musical composition. The individual vocal parts, audio stems, and video segments may be manipulated electronically to achieve results desired by a producer of the multimedia presentation. For example, audio stems and vocal tracks may be looped during the multimedia presentation.

Disclosed embodiments may include a mixer for combining external sound such as from microphones or musical instruments with prerecorded audio stems, video segments, and song lyrics. In some embodiments, audio stems are received locally and presented substantially in real time in a multimedia presentation. Output from disclosed systems may include a composite signal that includes audio stems, video segments, and song lyrics. In some embodiments, audio stems, video segments, and song lyrics include timing information. Such timing information may be used by disclosed systems to provide visual indicators with a portion of the song lyrics to aid viewers in singing together with or following the multimedia presentation. For example, a visual display that includes the video track and song lyrics may present song lyrics that change in color or are otherwise highlighted (e.g., bolded) in synchronization with a musical composition.

Using a graphical interface, a user may select one or more downloaded audio stems and video segments for inclusion with a multimedia presentation. In some embodiments, a user may select or manually enter (e.g., type using a keyboard) lyrics for inclusion with the multimedia presentation. After selection, indications of the selected audio stems and video segments are presented on a graphical interface. The graphical interface may display timing information and may display wave forms for each of the audio stems. In some embodiments, during a multimedia presentation, a user views each audio stem as a wave form superimposed on a timeline. Embodied systems may receive vocal signals, instrumental signals, and/or video signals from one or more live sources (e.g., a guitarist) or one or more external sources and include them with the multimedia presentation. In some embodiments, a producer may record and loop the signals received from such sources and loop them within the multimedia presentation. The vocal signals, instrument signals, and video signals may include a reference signal with timing information used for synchronization.

Downloaded music stems may be from any of several musical instruments and may be in any of several musical keys (e.g., in the key of C). Examples of musical instruments include, but are not limited to: bass guitar, piano, electric guitar, acoustic guitar, organ, bongos, chimes, drums, gong, trumpet, trombone, tambourine, banjo, harmonica, symbols, synthesizer, piccolo, violin, oboe and harp. The music stems may be in any of several audio formats including but not limited to WAV (Windows® Wave), WMA (Windows® Media Audio 8), WMV (Windows® Media Video), and MP3 (MPEG-½ Audio Layer III) MPEG, and .MOV. The music stems may have associated time codes used for synchronization. The time codes may be embedded in metadata and may include SMPTE time codes with a binary coded identifier that includes information in the following format: hour;minute;second;frame. In addition to music stems and video segments, one or more click tracks may be available for download. Typical click tracks provide a series of audio cues used to synchronize sound recordings and may be used by one or more musicians or producers during preparation or performance of a multimedia presentation.

When a musical composition is recorded, a corresponding master recording may be made. The master recording may be referred to as an “original master recording.” Masters may be recorded in digital or analog format. Copies of the recording for distribution may be made from the master recording. Recordings that are stored to computer hard disks and similar data storage devices may be referred to as “session files.” For some recordings, each microphone signal or line input (e.g., from an instrument) is recorded to its own track or stem on a multi-track recorder. Subsequently, the signals that are recorded on the multi-track format may be individually reproduced, compressed, enhanced (e.g., through noise reduction), equalized, and mixed to a mono or multi-channel (e.g., stereo) recording. A multi-track recording may be remixed in different ways according to preferences of producers and how it will be used. In some embodiments, multiple stems of the same track are stored in distinct musical keys. Musical composition masters (e.g., song masters) are often owned by the author of the musical composition or the author's assignee. The owner of the master may license copies of the master for playing by individuals, for example, using files on compact discs. A sale of the master typically refers to a purchase of intellectual property and, in many cases, the right to license others to make and play copies of the master. Disclosed services and methods may provide information to users regarding license terms in response to user input requesting the download of one or more stems or videos.

A single musical composition may be recorded in several tracks or stems. For example, one stem may be for lead vocals, one stem may be for backup vocals, one stem may be for guitar, and so on. A drum kit may have multiple microphones, and a mixing engineer may enhance multiple stems and save the enhanced stems as a downloadable drum kit stem. A mastering engineer or producer may process individual tracks and create a master recording, which results in a song or musical composition. In accordance with disclosed embodiments, mastered stems (e.g., from individual instruments) may be provided to users for download. In some embodiments, a service enables a user to select and download all stems for a song or musical composition except for one or more vocal stems (e.g., vocal stems). DRM information may be added to downloaded stems to control or limit the manner in which the stems are used subsequent to downloading. For example, the number of times the digital stem may be used, played, or copied may be limited to a predetermined number. In some embodiments, DRM features may prompt a user to renew a license for one or more downloaded stems.

In addition to providing individual music stems for download, disclosed embodiments can provide pre-recorded videos for download. Videos offered for download may be rendered and recorded to include song lyrics. Additionally, videos offered for download through disclosed embodiments may be synchronized, sized, and timed to match the length and makeup of the corresponding audio portions of the songs. Embodied services and methods, in response to user input or otherwise, may also include sizing a video segment to match the length of a song and providing the sized video segment for download. In addition, in response to user input, lyrics may be added into video segments automatically by disclosed methods and services and rendered for download by the user.

In the following description, details are set forth by way of example to facilitate discussion of the disclosed subject matter. It should be apparent to a person of ordinary skill in the field, however, that the disclosed embodiments are exemplary and not exhaustive of all possible embodiments. Throughout this disclosure, a hyphenated form of a reference numeral refers to a specific instance of an element and the un-hyphenated form of the reference numeral refers to the element generically or collectively. Thus, for example, widget 12-1 refers to an instance of a widget class, which may be referred to collectively as widgets 12 and any one of which may be referred to generically as a widget 12.

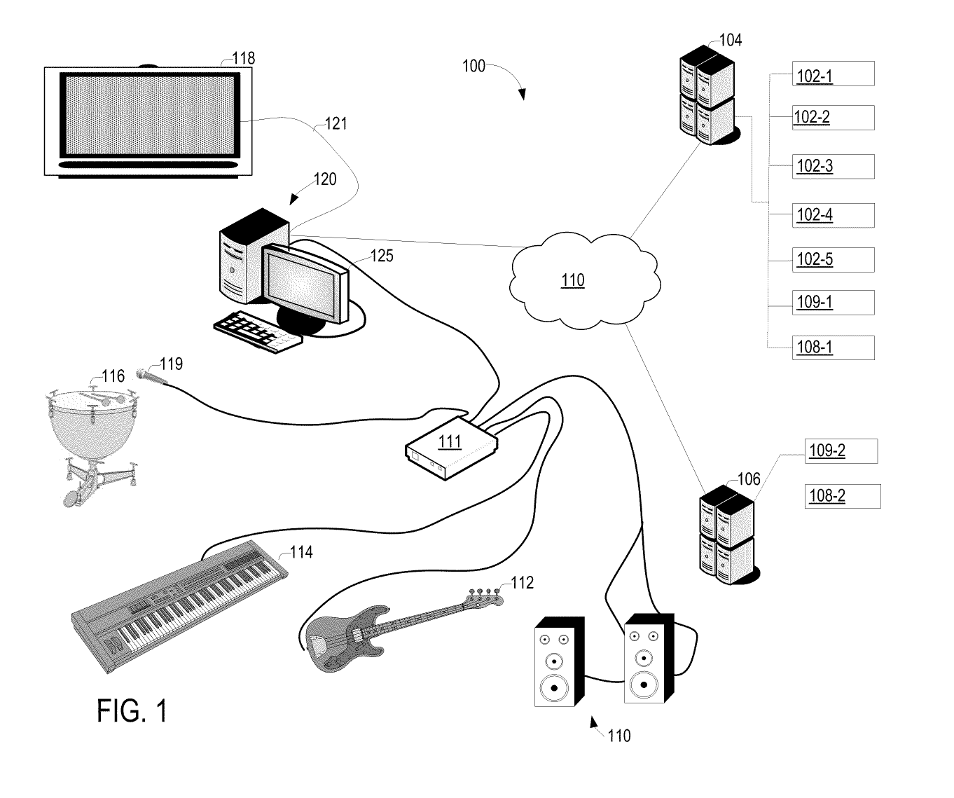

FIG. 1 shows an exemplary environment 100 with components for implementing one or more embodiments of a method for processing multimedia components for a multimedia presentation. Such components include digital audio workstation (DAW) 120 which is communicatively coupled through network 110 to service provider 104. Service provider 104 has access to lyric data 108-1, video track 109-1, and music stems 102-1 through 102-5. Although only five music stems are illustrated, a typical multimedia presentation my have sixteen or more music stems. As shown, third-party server 106 has access to video track 109-2 and lyric data 108-2, which may also be accessed by DAW 120. Third-party server 106 may access video track 109-2 and lyric data 108-2 in response to a request by DAW 120.

As shown in FIG. 1, audio mixer 111 receives audio input from a microphone 119 that picks up sound from kettle drum 116. Keyboard 114 and guitar 112 also provide audio input to audio mixer 111. DAW 120 receives one or more music stems 102 and encodes an audio output signal to audio mixer 111. Audio mixer 111 produces output for speakers 110. Audio mixer 111 may also include amplifying equipment (not depicted) for boosting the audio signal to speakers 110. In addition, audio mixer 111 may include or be coupled to equalizing equipment (not depicted) for adjusting sound levels of guitar 112, keyboard 114, kettle drum 116, and music stems 102. Display 118 provides the visible portions of multimedia presentations processed and produced in accordance with the disclosed embodiments. As shown, display 118 is communicatively coupled to DAW 120 and receives video signal 121 to produce a visual presentation that accompanies the audio output of speakers 110 to result in the multimedia presentation. The video signal 121 includes lyrics received through lyric data 108 and processed by DAW 120. Video signal 121 also includes video track 109-1 as processed by DAW 120. Accordingly, display 118 and speakers 112 are used for a multimedia presentation that includes live instrumental input (e.g., from guitar 112) and music stems 102 as requested, downloaded, and processed by DAW 120. The selection of components shown in FIG. 1 is for illustrative purposes and is not intended to limit the subject matter of the appended claims. Other components (e.g., converters, encoders, splitters) may be incorporated into disclosed systems but are omitted for clarity.

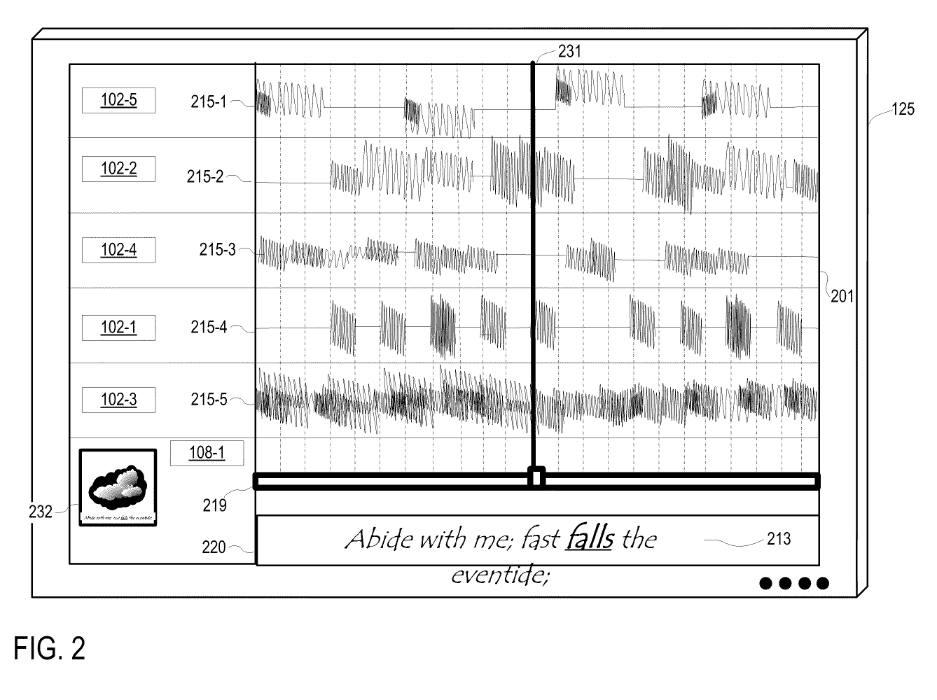

FIG. 2 depicts a graphical user interface (GUI) 201 presented by display 125 which, as shown in FIG. 1, is part of DAW 120. GUI 201 includes waveform 215-1 which provides a graphical indication of the amplitude of musical stem 102-5 over time. Similarly, waveform 215-2 provides a graphical indication for the amplitude of musical stem 102-2, waveform 215-3 provides a graphical indication for the amplitude of musical stem 102-4, waveform 215-4 provides a graphical indication of the amplitude for musical stem 102-1, and waveform 215-5 provides a graphical indication for the amplitude of musical stem 102-3. Thumbnail 232 provides a user with an image for a video track 108-1 for time 231. As shown, time bar 219 indicates the chronological location of the portion of the video segment corresponding to thumbnail 232. Lyrics window 220 includes lyrics 213. As shown, the word “falls” is highlighted (i.e., underlined and bolded) to indicate which lyrics should be performed at a particular moment in the multimedia presentation. Lyrics 213 may be entered by a user or may be downloaded with lyric data 108.

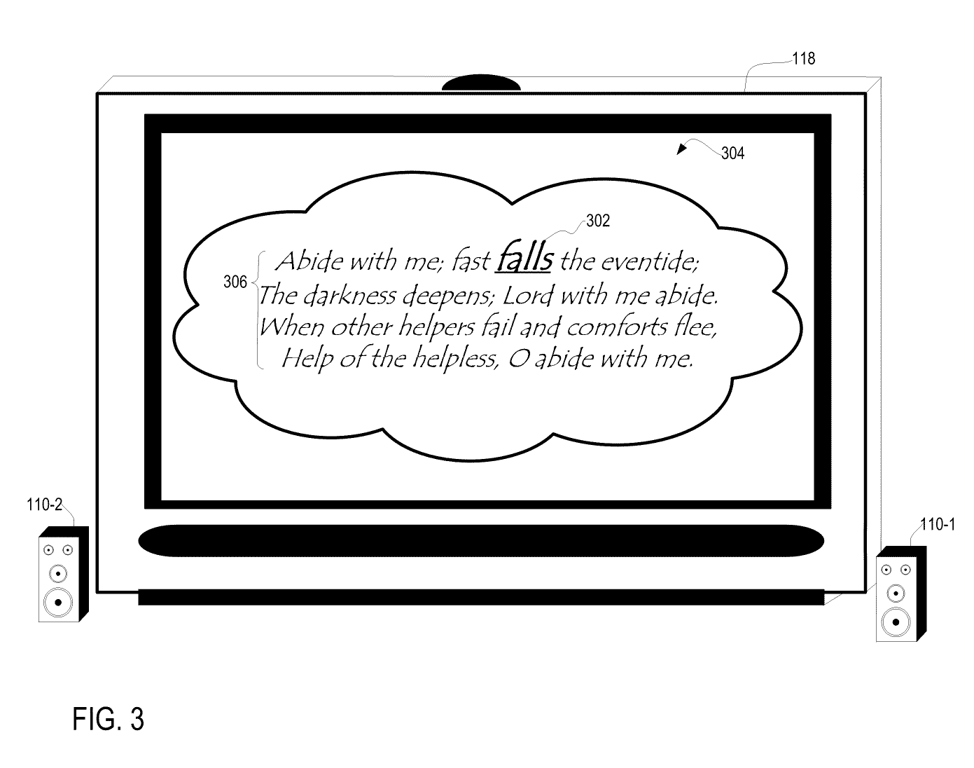

FIG. 3 depicts a display 118 with an exemplary screen shot 304. As shown, lyrics 306 include highlighted portion 302. The highlighted portion 302 is underlined and bolded, however other forms of highlighting may be used to indicate timing data for performance of the lyrics with the multimedia presentation. An audio portion of the multimedia presentation is provided by speakers 110.

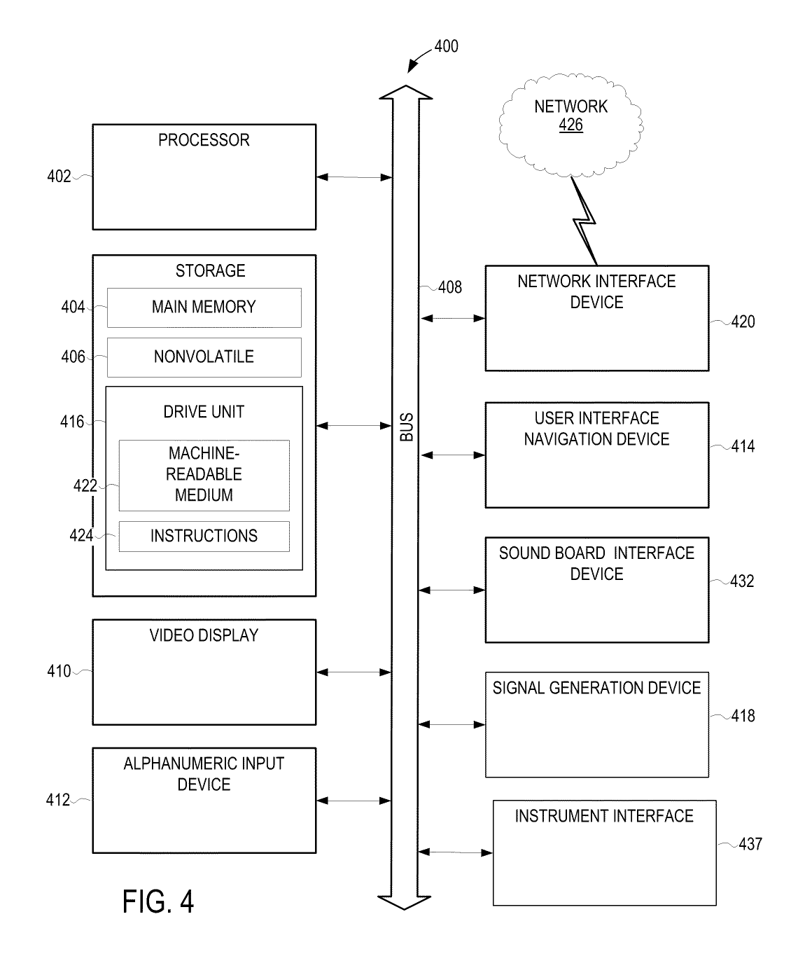

FIG. 4 illustrates in block diagram form a data processing system 400 within which a set of instructions may operate to perform one or more disclosed methods or services. Data processing system 400 may operate as a standalone device (e.g., DAW 120 in FIG. 1) or may be connected (e.g., networked) to other data processing systems. In a networked deployment, data processing system 400 may operate in the capacity of a server or a client data processing system (i.e., computer) in a server-client network environment, or as a peer computer in a peer-to-peer (or distributed) network environment. Example data processing systems include, but are not limited to, a DAW, a mixer, personal video recorder, a personal computer (PC), a web appliance, a network router, a switch, a bridge, a server, or any machine or component capable of executing a set of instructions (sequential or otherwise) that specify actions to be taken by that machine or component. Further, while only a single data processing system is illustrated, the term “data processing system” shall also be taken to include any collection of data processing systems that individually or jointly execute a set (or multiple sets) of instructions to perform any one or more of the disclosed methods or services.

As shown, data processing system 400 includes a processor 402 (e.g., a central processing unit, a graphics processing unit, or both), a main memory 404, and a nonvolatile memory 406 that may communicate with each other via a bus 408. In some embodiments, main memory 404 and/or nonvolatile memory 406 may be used to store the video segments, music stems, and lyrics information. Data processing system 400 may further include a video display unit 410 (e.g., a television, a liquid crystal display or a cathode ray tube) on which to display waveforms of music stems, timing information, thumbnail views of a multimedia presentation, and the like. Data processing system 400 also includes an alphanumeric input device 412 (e.g., a keyboard), a user interface (UI) navigation device 414 (e.g., a mouse), a drive unit 416, a signal generation device 418 (e.g., a speaker) and a network interface device 420. The input device 412 and/or the UI navigation device 414 may include a processor (not shown), and a memory (not shown). The drive unit 416 includes a machine-readable medium 422 that may have stored thereon one or more sets of instructions and data structures (e.g., instructions 424) embodying or utilized by any one or more of the functions, services, or methods described herein. The instructions 424 may also reside, completely or at least partially, within the main memory 404, within nonvolatile memory 406, within video display 410, within alpha numeric input device 412, within network interface device 420, within signal generation device 418, within sound board interface device 432, within instrument interface device 437, and/or within the processor 402 during execution.

The instructions 424 may further be transmitted or received over a network 426 via the network interface device 420 utilizing any one of a number of transfer protocols (e.g., broadcast transmissions, HTTP). While the machine-readable medium 422 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” should also be taken to include any medium that is capable of storing, encoding or carrying a set of instructions for execution by the machine (i.e., data processing system) and that cause the machine to perform any one or more of the disclosed services, functions, or methods, or that is capable of storing, encoding or carrying data structures utilized by or associated with such a set of instructions. The term “machine-readable medium” shall accordingly be taken to include, but not be limited to, solid-state memories, optical disks, and magnetic media.

In accordance with disclosed embodiments, instructions 424 may include instructions for downloading one or more audio stems, downloading one or more video segments, synchronizing the one or more video segments with the one or more audio stems, receiving lyrics data, and synchronizing the lyrics data with the one or more audio stems. Video segments may include lyrics data and timing data. In some embodiments, the lyrics data is downloaded and in some embodiments the lyrics are entered locally at a DAW, for example, using alphanumeric input device 412. Further instructions may enable looping a portion of the one or more audio stems and looping the one or more video segment stems. Further instructions encode the one or more audio stems for distribution to a mixer, validate DRM data, and enable a user to perform transport controls that include pausing, rewinding, playing, or stopping a multimedia presentation. In some embodied systems, instructions present a visual indicator of lyrics timing data (e.g., highlighted song lyrics) in the multimedia presentation.

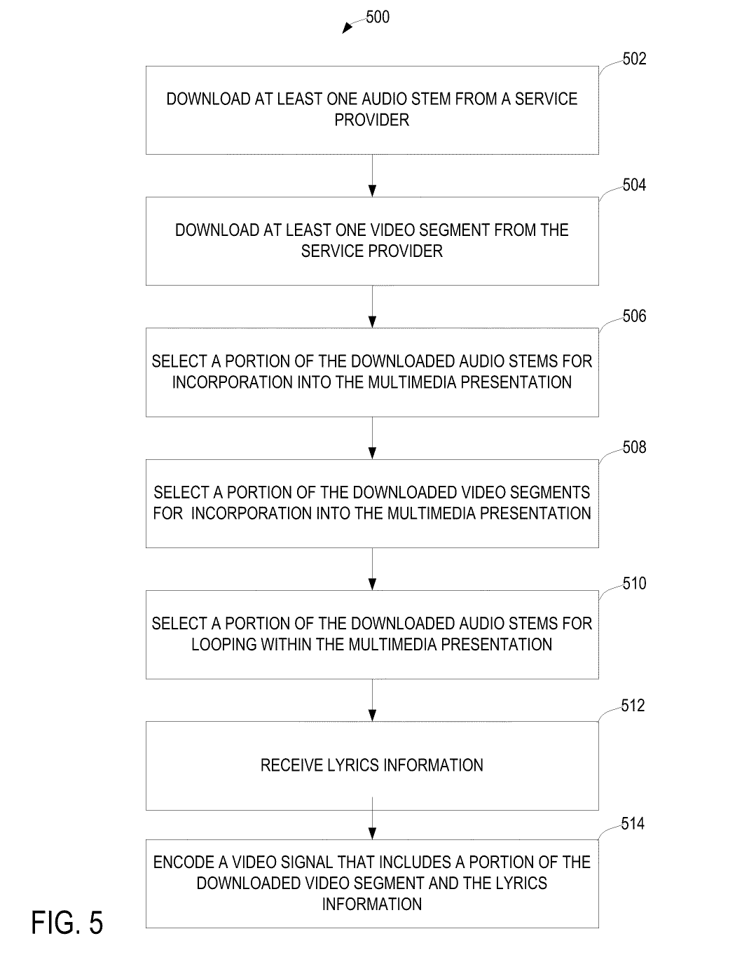

FIG. 5 depicts selected elements of a disclosed a method 500 of processing components of a multimedia presentation. As shown, method 500 includes downloading (block 502) at least one audio stem from a service provider. The stem may be a guitar track, a piano track, a bass track, or a vocal track, as examples. The method further includes downloading (block 504) at least one video track from the service provider. The video track may be a background that is shown on a display along with lyrics. A portion of the downloaded stems are selected (block 506) and a portion of the downloaded video segments are selected (block 508) for incorporation into the multimedia presentation. In some embodiments, the incorporation into the multimedia presentation occurs substantially in real time with downloading. Method 500 further includes selecting (block 510) a portion of the downloaded audio stems for looping within the multimedia presentation. Lyrics information may be received (block 512) and included with the multimedia presentation. The lyrics information may include timing information (e.g., SMPTE time codes) for synchronization to downloaded audio stems. As shown, method 500 includes encoding a video signal that includes portions of the downloaded video track and lyrics information. In some embodiments, the lyrics are retrieved from a third-party source and overlaid upon a video image. In other embodiments lyrics may be included from the service provider with the video track. In some embodiments, riff data is downloaded and incorporated into the multimedia presentation. For example, a local guitar player may play a guitar riff that is incorporated into the multimedia presentation with audio elements downloaded from the remote service provider. In some cases, the riff data is looped within the multimedia presentation.

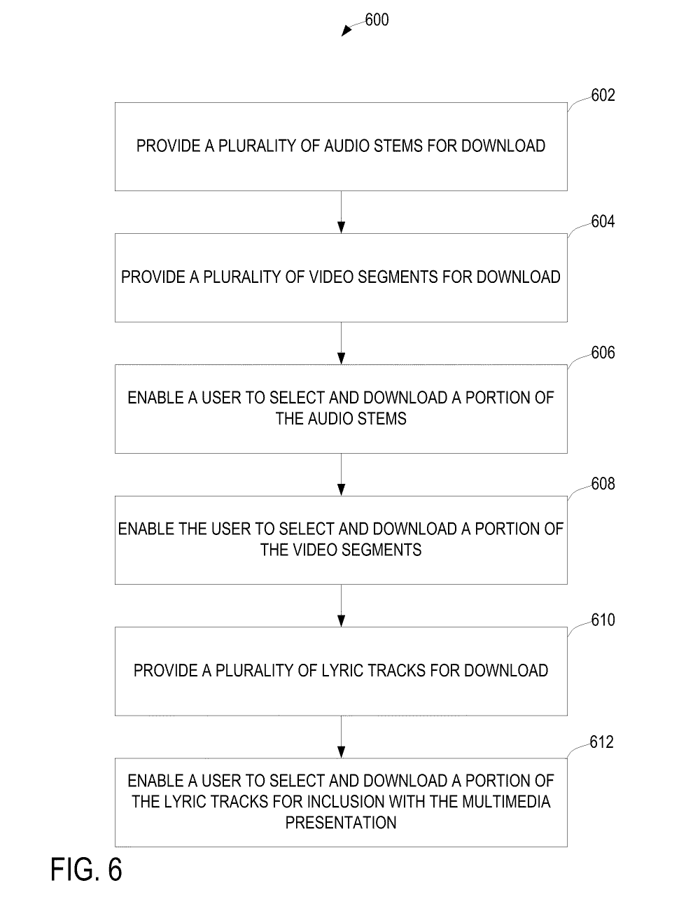

FIG. 6 depicts selected elements of a disclosed service 600 of providing multimedia components for a multimedia presentation. As shown, service 600 includes providing (block 602) a plurality of audio stems for download. A user is enabled (block 606) to select and download a portion of the audio stems. The audio stems may be selectable according to a musical key. The audio stems may include DRM data to control the playing of the audio stems. Service 600 further includes providing (block 604) a plurality of video segments for download. In some embodiments, the video tracks include lyrics. A user is enabled (block 608) to select and download a portion of the video segments. The downloaded video segments are synchronized with the portion of the audio stems and included with the multimedia presentation. The video segments may include a plurality of frames that have time codes (e.g., SPMTE time codes) used for synchronization with the audio stems. In some embodiments, the downloaded audio stems and video segments are buffered for inclusion with the multimedia presentations substantially in real time as they are downloaded. Service 600 further includes providing (block 610) a plurality of lyric tracks for download and enabling (block 612) a user to select and download a portion of the lyric tracks for inclusion with the multimedia presentation. In addition, click tracks that are timed to correspond to the audio stems may be provided for download.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the claimed subject matter is to be determined by the broadest permissible interpretation of the following claims and their equivalents, and shall not be restricted or limited by the foregoing detailed description.

What is claimed is:

1. A service for providing multimedia components for a multimedia presentation, the service comprising:
providing a plurality of audio stems for download;
providing a plurality of video segments for download;
enabling a user to select and download a portion of the audio stems; and
enabling the user to select and download a portion of the video segments, wherein the portion of video segments are for synchronization with the portion of the audio stems for inclusion with the multimedia presentation.

2. The service of claim 1, further comprising:
providing a plurality of lyric tracks for download; and
enabling the user to select and download a portion of the lyric tracks for inclusion with the multimedia presentation.

3. The service of claim 1, wherein the portion of the video segments include lyrics.

4. The service of claim 1, wherein a portion of the audio stems include digital rights management (DRM) data.

5. The service of claim 1, further comprising:
buffering the portion of audio stems for substantially real time inclusion in the multimedia presentation.

6. The service of claim 1, further comprising:
buffering the portion of video segments for substantially real time inclusion in the multimedia presentation.

7. The service of claim 1, further comprising:
providing a plurality of audio click tracks for download, wherein the plurality of audio click tracks are timed to correspond individually to the plurality of audio stems;
enabling a user to select and download a portion of the plurality of audio click tracks.

8. The service of claim 1, wherein the audio stems are prerecorded.

9. The service of claim 1, wherein one or more of the plurality of audio stems are selectable according to a musical key.

10. The service of claim 1, wherein the portion of the video segments includes a plurality of frames, wherein individual frames of the plurality of frames include time codes.

11. The service of claim 10, wherein the time codes are Society of Motion Picture and Television Engineers (SMPTE) time codes.

12. A computer program product stored on at least one computer readable medium, wherein the computer program product is for processing a plurality of components of a multimedia presentation, wherein the computer program product comprises instructions for:
downloading one or more audio stems from a service provider;
downloading one or more video segments from the service provider;
synchronizing the one or more video segments with the one or more audio stems;
receiving lyrics data; and
synchronizing the lyrics data with the one or more audio stems.

13. The computer program product of claim 12, wherein said receiving lyrics data includes downloading the lyrics data.

14. The computer program product of claim 12, further comprising instructions for:
looping a portion of the one or more audio stems.

15. The computer program product of claim 12, further comprising instructions for:
looping a portion of the one or more video segments.

16. The computer program product of claim 12, further comprising instructions for:
receiving an instrument signal for integration into the multimedia presentation.

17. The computer program product of claim 12, further comprising instructions for:
encoding the one or more audio stems.

18. The computer program product of claim 12, further comprising instructions for:
validating digital rights management data associated with the one or more audio stems.

19. The computer program product of claim 12, further comprising instructions for:
providing transport controls that include one or more of pausing, rewinding, playing, or stopping the multimedia presentation.

20. The computer program product of claim 12, wherein said downloading video segments includes receiving video timing data.

21. The computer program product of claim 20, wherein said downloading lyrics data includes receiving lyrics timing.

22. The computer program product of claim 21, further comprising;
presenting a visual indicator of the lyrics timing data in the multimedia presentation.

23. A method of processing components of a multimedia presentation, the method comprising:
downloading at least one audio stem from a service provider;
downloading at least one video track from the service provider;
providing for selection a portion of the downloaded audio stems for incorporation into the multimedia presentation;
providing for selection a portion of the downloaded video segments for incorporation into the multimedia presentation;
presenting the multimedia presentation with a selected portion of the downloaded video segments and with a selected portion of the downloaded audio stems.

24. The method of claim 23, wherein said presenting occurs substantially in real time with said downloading.

25. The method of claim 23, further comprising:
selecting a portion of the downloaded audio stems for looping within the multimedia presentation.

26. The method of claim 23, further comprising:
receiving lyrics information; and
encoding a video signal that includes a portion of the downloaded video track and the lyrics information.

27. The method of claim 26, wherein the lyrics information includes timing information for synchronization to the at least one downloaded audio stem.

28. The method of claim 27, wherein the timing information includes a Society of Motion Picture and Television Engineers (SMPTE) time code.

29. The method of claim 23, further comprising:
receiving riff data; and
incorporating the riff data into the multimedia presentation.

30. The method of claim 29, wherein said incorporating includes looping the riff data.
